(19) United States
(12) Patent Application Publication
(10) Pub. No.: US 2022/0101240 A1
(43) Pub. Date: Mar. 31, 2022

(54) Shopping System With Improved Matching

(71) Applicant: Mercatus Technologies Inc., Toronto (CA)

(72) Inventor: Nadeem KASSAM, Etobicoke (CA)

(73) Assignee: Mercatus Technologies Inc., Toronto, ON (CA)

(21) Appl. No.: 17/420,700

(22) PCT Filed: Jan. 6, 2020
(86) PCT No.: PCT/CA2020/050010

§ 371 Date: Jul. 5, 2021

Related U.S. Application Data
(60) Provisional application No. 62/789,098, filed on Jan. 7, 2019.

(51) Int. Cl. G06Q 10/06; G06Q 10/08; G06Q 30/06

(52) U.S. Cl. CPC G06Q 10/063112; G06Q 30/0601; G06Q 10/087; G06Q 10/0832

(57) ABSTRACT

The present invention describes several embodiments in which a customer orders items from a grocery store using an electronic shopping interface that allows him or her to select a designated picker among a plurality of pickers available at the store. The designated picker is a person selected to pick perishable items from the store. This helps bridge the trust gap that consumers have with grocery stores, particularly with regard to perishable items such as vegetables. The invention enables improved customer satisfaction for the consumer and substantial business opportunity for a grocer with an online electronic commerce platform.

### TECHNICAL FIELD

The present disclosure relates generally to shopping systems for online commerce and more particularly to shopping systems that offer improved reliability and customized experience for consumers of perishable items.

### BACKGROUND

Systems for electronic commerce where consumers order items online, provide an address for delivery, and the where retailer fulfils the order by preparing and delivering the requested items to the delivery address are known.

Electronic commerce has proven especially attractive for digital content such as digital music, where in addition to the fidelity of the product the ease and speed with which the consumer is able to receive and enjoy the product makes electronic commerce very attractive.

In addition to digital content, for purchase of standardized physical goods where there are no meaningful differences between items of the same specification, many consumers have proven willing to order items online—fairly confident that what would be delivered to their specified address upon fulfilment of their order will match their expectation. The enormous growth of electronic commerce is a testament to the increasing willingness of consumers to engage in online shopping of standard nonperishable items such as books and electronic items.

However, where the items are not uniform or standardized, the use of online commerce tends to lag far behind the market for standardized nonperishable items such as books or electronic devices. For example, consumers are hesitant to order perishable items such as vegetables online due to quality concerns.

Many vegetarians struggle with exercising the option to order perishable grocery items online. The risk of disappointment is often rightly perceived as quite high, that the perishable items that would be shipped and delivered may not be to the vegetarian consumers' liking.

Accordingly, improved shopping systems that mitigate some aspects of the aforementioned problems are desired.

### SUMMARY

In accordance with one aspect of the present disclosure, there is provided a method of electronic commerce that includes, at a server, maintaining a plurality of item identifiers corresponding to a plurality of items maintained at a store, maintaining a plurality of picker profiles corresponding to a plurality of pickers, and receiving an order from a buyer. The order includes an item identifier among the item identifiers associated with at least one of the plurality of items to be purchased at the store; and a picker identifier associated with at least one of the plurality of pickers, in response to the receiving the order. The method further includes notifying the at least one of the plurality of pickers associated with the picker identifier, wherein the at least one of the plurality of pickers selects the at least one item at the store for delivery to the buyer.

In accordance with one aspect of the present disclosure, there is provided a server system, including: a processor; a memory; a communication interface; and a non-transitory processor readable medium storing processor executable instructions configured to be executed by the processor, the processor executable instructions for: maintaining a plurality of item identifiers corresponding to a plurality of items maintained at a store; maintaining a plurality of picker profiles corresponding to a plurality of pickers; receiving an order from a buyer, the order including: an item identifier among the item identifiers associated with at least one of the plurality of items to be purchased at the store; and a picker identifier associated with at least one of the plurality of pickers, in response to the receiving the order, notifying the at least one of the plurality of pickers associated with the picker identifier, wherein the at least one of the plurality of pickers selects the at least one item at the store from for delivery to the buyer.

In accordance with one aspect of the present disclosure, there is provided a client system having: a processor, memory, a communications interface, an input interface and a non-transitory processor readable medium. The medium stores processor executable instructions to be executed by the processor. The processor executable instructions include instructions for: receiving, through the input interface, an item identifier among said item identifiers associated with at least one of the plurality of items to be purchased at the store; receiving, through the input interface, a picker identifier associated with at least one of said plurality of pickers; and sending the picker identifier and the item identifier to a server system in data communication with the client system through said communications interface.

In accordance with one aspect of the present disclosure, there is provided a non-transitory processor readable medium storing processor executable instructions which when executed by a server computer cause the server to perform a method including: maintaining a plurality of item identifiers corresponding to a plurality of items maintained at a store; maintaining a plurality of picker profiles corresponding to a plurality of pickers; receiving an order from a buyer, the order including: an item identifier among the item identifiers associated with at least one of the plurality of items to be purchased at the store; and a picker identifier associated with at least one of the plurality of pickers, in response to the receiving the order, notifying the at least one of the plurality of pickers associated with the picker identifier, wherein the at least one of the plurality of pickers selects the at least one item at the store from for delivery to the buyer.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF DRAWINGS

In the accompanying figures, which illustrate by way of example only, one or more embodiments of the present invention:

FIG. 1 is a schematic system block diagram of a system for utilizing a client device running an application, a server, and a grocery store having a number of pickers, in a first embodiment of the present invention;

FIG. 2 is a simplified block diagram of hardware components of the exemplary server computing device used in FIG. 1;

FIG. 3 is a simplified block diagram of hardware components of one of the mobile client devices depicted in FIG. 1;

FIG. 4 is a schematic illustration of an examples of a graphical user interface of the application run by the customer using one of the client devices of FIG. 1;

FIG. 5 is a schematic block diagram of a pop up window of the graphical user interface of FIG. 4, highlighting the profile of one of the pickers of FIG. 1;

FIG. 6 is a schematic block diagram of another popup window providing additional information on the profile of the picker of FIG. 5;

FIG. 7 is a flowchart illustrating a set of exemplary procedural steps taken by a customer's computing device of FIG. 1 running a grocery shopping application; and

FIG. 8 is a flowchart illustrating a set of exemplary steps taken by the server of FIG. 1 corresponding to the steps outlined in FIG. 7.

### DETAILED DESCRIPTION

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

Directional terms such as “top”, “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

As noted earlier, conventional systems for ordering items online from retailers are known. A consumer that wants to place an order uses a client side system of hardware and software, such as a personal computer running a web browser, a mobile device with a compatible app, or another web-enabled software and hardware, to send the request for information describing the item to be ordered. The server system sends the requested information (e.g., via a web page) to the client system along with an indication of actions to perform on a user interface to place the order for the item. When the consumer performs the required actions, the client system sends related instructions to the server system which completes the order.

Conventional electronic shopping works well for non-perishable items. However, as noted above, consumers are hesitant to purchase perishable items online due to quality concerns. Lack of uniformity in the items to be ordered implies that there is a degree of subjectivity involved in the choosing perishable items that are suitable for the buyer.

Note that this problem does not generally arise with nonperishable items having predictable, standard and fairly uniform characteristics. For example, book retailers with online shopping platforms do not typically have to deal with this problem. If a consumer is interested in a hardcover book of a particular title and edition by a particular author, then he or she can simply order a copy of the book online. Any hardcover copy of the book can be shipped to the consumer with a very high degree of certainty that the product will be satisfactory. Neither the book retailer nor the buyer will be unduly concerned that the book that arrives will not meet the expectations of the buyer.

The same can be observed with electronics retailers. If a consumer is interested in a particular digital camera or a memory stick, then the consumer can place an electronic order for the unit by specifying the make and model of the digital camera or memory stick and have it shipped.

### Perishable Items

In the case of digital content such as digital music, digital books or digital movies, the characteristics of the items being ordered are identical and thus indistinguishable. The same may be said for manufactured goods such as electronic gadgets, manufactured household wares and the like, if the goods are free of defects.

However, a grocery store with an online presence will have to help ensure that items selected for shipping or to be picked up by the consumer, which are often perishable items, indeed match the often highly subjective and nuanced tastes and preferences of the buyer. The consumer is, often justifiably, quite concerned whether the perishable items ordered online will match expectations when actually delivered.

Conventional online grocery store maintain one or more employees who will fulfill online orders. These employees may be dedicated pickers or may have other additional responsibilities such as stocking items, customer service duties, manning cash registers or controlling inventory. Typically, a computer server handling online orders for the grocer selects a picker from the available pool of employees that care capable of picking items. The selection is often made on the basis of some metric such as average picking speed, availability until next break, total hours worked in a given period, compensation rate or the like. A conventional retailer's server system can also select a picker from the available employees randomly or in a round robin fashion.

While having flexibility in the way the conventional online grocery store assigns a picker among its available employees may be advantageous from a scheduling and logistics perspective for the grocery store, the inability to have some control over the picker is often perceived as a disadvantage for the consumer.

As noted earlier, many consumers of specific types of food items such as vegetarian food or organic food, for example, often hesitate to utilize of an online grocery purchase. For a vegetarian consumer, if the assigned picker, over whom he or she has no control, fails to choose and pick the types of vegetables that the vegetarian himself or herself would choose, the result is very likely disappointment, leading to loss of the consumer as future customer, potentially for good.

These problems may entail serious repercussions in the market place. For example, a Pulse survey of 2036 respondents indicated that among the motivations or reasons for not shopping online is “not seeing/touching product and fresh goods” which was the most frequent response by 419 respondents.

Another motivation according to the survey was “I am worried the product quality won't be as good” which was the fifth most common response by 226 respondents.

Yet another motivation according to the survey was “food safety and food handling concerns” which was the seventh most common response by 119 respondents.

Fully 92% of the respondents that have had their groceries delivered to them felt the quality of products picked for them was as good or better than if they had picked it themselves (52% felt it was better).

Further, 86% of the respondents that have picked up their groceries curbside felt the quality of products picked for them was as good or better than if they had picked it themselves (22% felt it was better).

One of the effects of embodiments of the present invention is to help bridge that trust gap between the consumer and the grocer. This is accomplished generally via a picker and more specifically by appropriate matching of a shopper or consumer and a suitable picker. In embodiments of the present invention, after a customer selects their store and builds their cart, he or she will have an opportunity to choose the designated picker, that is, the person that picks their perishable items from the grocery store.

Bridging the trust gap will thus likely translate to improved customer satisfaction for the consumer and substantial business opportunity for a grocer with an online electronic commerce platform.

Overall Architecture of System with Picker Selection

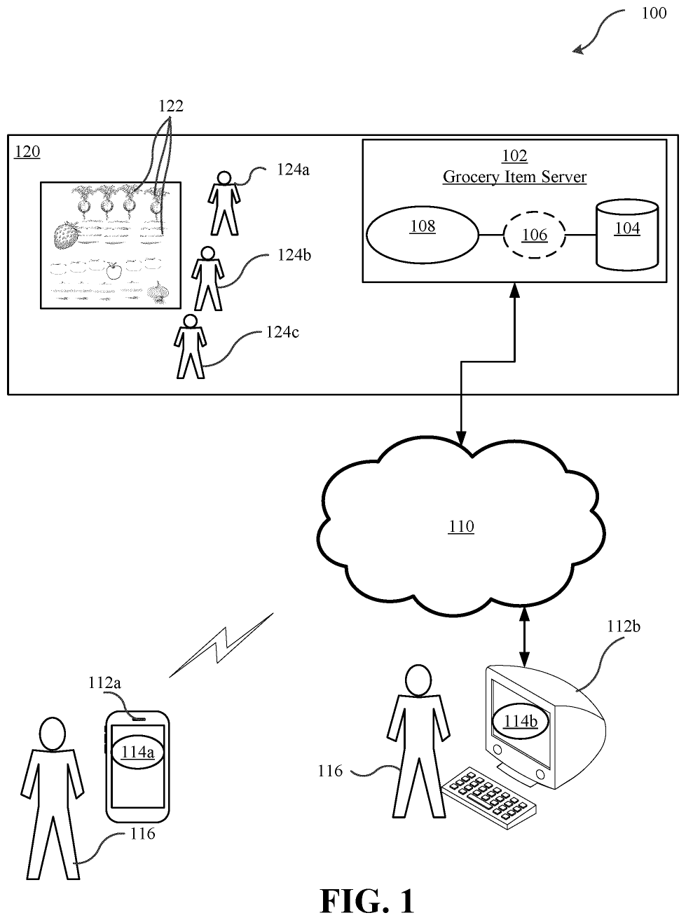

A system that allows the consumer to select a picker that is likely to pick items in a manner that is consistent with the preferences of the consumer, is therefore desirable. Accordingly, a system exemplary of an embodiment of the present invention includes a server and a client device as illustrated in FIG. 1.

FIG. 1, depicts a simplified block diagram of a system 100 that includes a store 120 containing multiple items 122 for sale which may include perishable items such as vegetables and fruits as well as other items available for sale either in the physical store 120 or online.

A grocery store server 102 in data communication with one or more digital electronic or computing devices 112a, 112b (individually and collectively, “devices 112”) via a network 110 hosts an online e-commerce platform for the store 120.

The server 102 includes a server-side software, the components of which may include a database 104, an application server 108 and a business application logic 106 and adapted for facilitating communication between the database 104 and the application server 108. Application server 108 is adapted for communicating with client side applications 114a, 114b (individually and collectively, application 114 or “app 114”) running on a devices 112a, 112b respectively. The application server 108 can be any suitable application server that is adapted to permit applications, apps, client applications or browser software, running on devices 112, to access data on server 102 through network 110. Suitable application server includes, but is not limited to, the Apache HTTP Server, the Internet Information Server (IIS). In other embodiments, the server side computing system can be a system comprising a network of computers (e.g. database server computer, application logic server computer, web-server computer), or a cloud service that uses a large network of server computers (e.g. database server computers, application logic server computers, web-server computers), the server computers collectively hosting multiple instances of application logic server software, database software, and application server. In other embodiments, the system does not include a application server running on a server that communicates to an app running on devices 112.

Each of the computing devices 112 access the grocery store server 102 through an application 114 running thereon, such as a browser (e.g., Chrome™, Internet Explorer™, Mozilla Firefox™, Safari™) or a mobile browser software, via the Hypertext Transfer Protocol (HTTP) or its secure version (HTTPS) for data entry, shopping item selection, payment data entry, delivery address data entry, shipping address data entry, and various other activities enabled by the electronic commerce platform as will be described later. In other embodiments, the server is not accessed via HTTP or HTTPS, but instead is accessed via another suitable protocol.

Application logic 106 executing on server 102 implements application logic rules for system 100. As contemplated in this first embodiment, application logic 106 can be implemented as software components, services, server software, or other software components forming part of application logic 106. Application logic 106 encodes specific business rules determining the creation, manipulation, alteration, generation, or verification of data using data received from devices 112 or retrieved from database 104.

Database 104 provides storage for persistent data. Persistent data includes, but is not limited to, data related to items for sale in a store, such as name, prices, promotion periods, discounts, eligibility criteria, coupon information and the like. As is known in the art, persistent data is often required for applications that reuse saved data across multiple sessions or invocations. As contemplated in this first embodiment, database 104 is supported by a relational database management software (RDBMS), and is encrypted.

Suitable RDBMS include, but are not limited to, the Oracle® server, the Microsoft SQL Server database, the DB2 server, MySQL server, and any alternative type of database such as an object-oriented database server software. Encryption can be done by any method known in the art. Suitable encryption methods or algorithms include, but are not limited to, RSA public-key encryption, Advanced Encryption Standard (AES), Triple Data Encryption Algorithm (3DES), and Blowfish. In other embodiments, the database on the server side computing system is not an RDBMS. In other embodiments, the database is not encrypted.

In alternate embodiments, server 102 has a separate database server hardware to host database 104. In other embodiments, the system has a separate application server computer for the purpose of providing additional resources in terms of processors, memory capacity, and storage capacity in order to improve the performance of the system. In other embodiments, the system further comprises a business logic server that is external to server 102, the business logic server for hosting an application logic (e.g. application logic 106). Other computing devices suitable for communication with server 102 or as devices 112 include, but are not limited to, server class computers, workstations, personal computers, and any other suitable computing device.

In this first embodiment, network 110 is the Internet. In other embodiments, the network can be any other suitable network including, but not limited to, a cellular data network, Wi-Fi™, Bluetooth™, WiMax™, IEEE 802.16 (WirelessMAN), and any suitable alternative thereof. The suitable data communications interface contemplated in this embodiment between devices 112 and network 110 is wireless. The interface can be an antenna, a Bluetooth™ transceiver, a Wi-Fi™ adapter, or a combination thereof.

As contemplated in this first embodiment, device 112a may be smartphone or another handheld electronic device. Non-limiting examples of such devices include smartphone (e.g. iPhone™, Blackberry™, Windows™ Phone, Android™ phone), personal digital assistant (PDA), cellular telephone, media player (e.g. iPod™), and a device which combines one or more aspects or functions of the foregoing devices.

On the other hand, device 112b may be a desktop or laptop computer, such as a personal computer (PC) or laptop running Windows® or Linux, MacBook®, MacBook® Pro, MacBook Air®, iMac®, Mac® Mini, or Mac Pro® from Apple Inc. In other embodiments, the devices can be any other suitable electronic devices having a suitable data communications interface to network 110. One or more of devices 112 are used by the consumers to participate in electronic commerce.

### Server Hardware

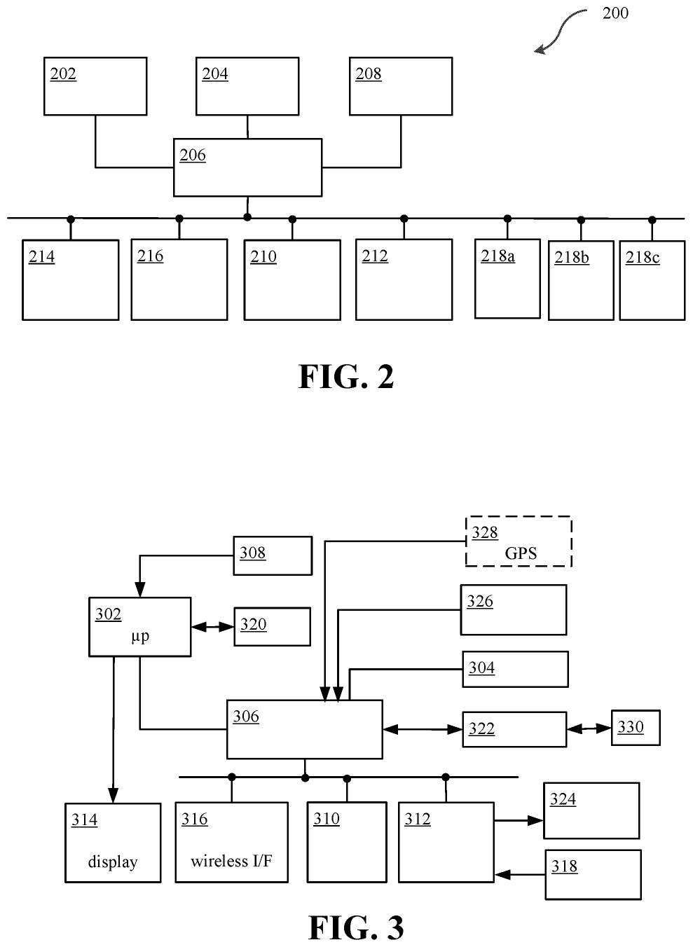

FIG. 2, depicts a simplified block diagram of computing device hardware 200. Hardware 200 comprises a processor 202 such as, but not limited to, a microprocessor, central processing unit (CPU), a digital signal processor (DSP) or the like; a memory medium 204, and interface circuit 206 adapted to provide a means of communication between processor 202 and memory medium 204.

Interface circuit 206 also interconnects input and output (I/O) components such a display 214, a network adapter 216, and a storage medium 210. Interface circuit 206 also interconnects a printer 212 and one or more additional peripherals 218a to 218c (individually and collectively, peripherals 218). Suitable peripherals 218 include, but are not limited to a keyboard, a camera, a scanner, a touch panel, a joystick, an electronic mouse, touch screen, track-pad, and other input or pointing devices, and any combination thereof. In other embodiments, the interface circuit does not interconnect a printer. In other embodiments, the interface circuit does not interconnect any peripherals.

Memory medium 204 may be in the form of volatile memory or a combination of volatile and non-volatile memory, including, but not limited to, dynamic or static random access memory (RAM), read-only memory (ROM), flash memory, solid state memory and the like.

Interface circuit 206 includes a system bus for coupling any of the various computer components 210, 212, 214, 216, 218 to the processor 202. Suitable interface circuits include, but are not limited to, Industry Standard Architecture (ISA), Micro Channel Architecture (MCA), Extended Industry Standard Architecture (EISA), VESA Local Bus (VLB), Peripheral Component Interconnect (PCI), Peripheral Component Interconnect Extended (PCI-X), Accelerated Graphics Port (AGP), Peripheral Component Interconnect Express (PCIe).

Storage medium 210 can be any suitable storage medium including, but not limited to, a hard disk drive (HDD), a solid state drive (SSD), EEPROM, CD-ROM, DVD, and any other suitable data storage element or medium. Storage medium 210 is readable by processor 202.

Display 214 can be any suitable display including, but not limited to, monitor, a television set or a touch screen.

Network adapter 216 in server 102 facilitates wired or wireless connections to an Ethernet, Wi-Fi™, Bluetooth™, cellular network or other suitable network, thereby enabling connection to shared or remote drives, one or more networked computer resources, other networked devices, I/O peripherals and the like. Devices 112 also contain complementary network adapters therein for connecting with a suitable network, and are further equipped with browser or other thin-client or rich-client software. As contemplated in this embodiment, network adapter 216 comprises a wireless network interface card that allows communication with other computers through a data network such as network 110. In other embodiments, the network adapter does not comprise a wireless network interface card. In other embodiments, the network adapter communicates with the network via a wired connection.

In some embodiments, the hardware architectures of computing device 112b and server 102 may be as depicted in FIG. 2.

### Client Device Hardware

FIG. 3, depicts a simplified block diagram of exemplary embodiment of a client device hardware such as mobile device 112a. Device 112a comprises a processor 302 such as, but not limited to, a microprocessor, a memory 304, an input interface 308, a battery 320, and a display 314. Several components and processor 302 communicate with each other through an interface circuit 306. Interface circuit 306 also interconnects components including, but not limited to, a wireless network interface 316, a storage medium 310, an input-output (I/O) interface 322, a camera 326, an audio codec 312 and a positioning module 328 such as a GPS unit. Audio codec 312 in turn connects to one of more microphones 318 and one or more speakers 324. A sensor 330 and/or other components may interconnect to processor 302 via I/O interface 322.

Wireless network interface 316 includes one or more of a wireless LAN transceiver (e.g. Wi-Fi™ transceiver), an infrared transceiver, a Bluetooth™ transceiver, and a cellular telephony transceiver. I/O interface 322 may include one or more wired power and communication interfaces such as a USB port.

Input interface 308 may be a keypad or keyboard, a touch panel, a multi-touch panel, a touch display or multi touch display having a software keyboard or keypad displayed thereon.

In operation, a customers will be presented with various picker profiles on device 112. Each picture profile includes one or more of a picture or image of the person, name, number of years working in the grocery, family size, dietary restrictions, working hours, and the like.

### Client Use Interface

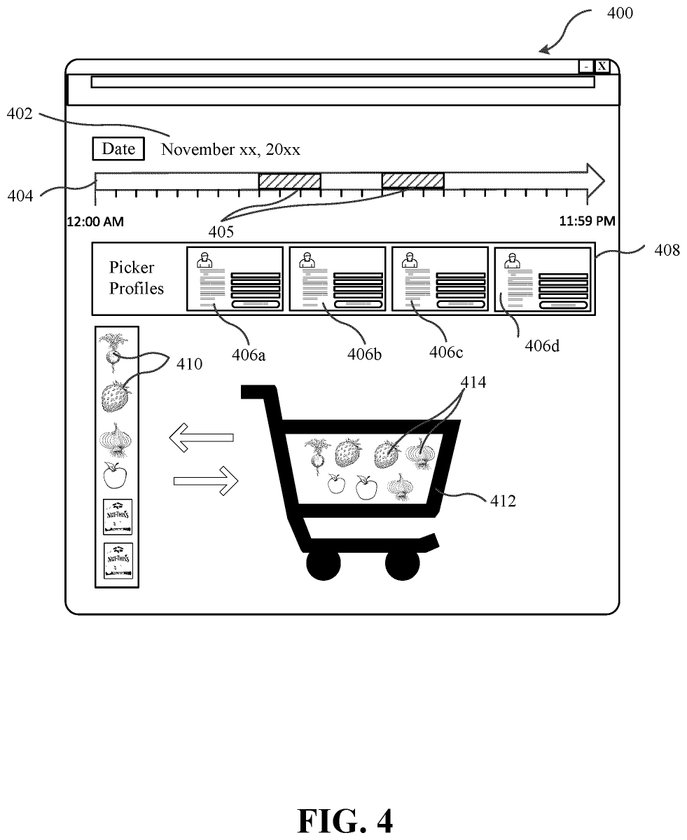

As depicted in FIG. 4 the application 114 executing on device 112 includes an exemplary graphical user interface (GUI) 400. The GUI 400 for application 114 may include user interface elements in the form of buttons, tabs, lists, images, text, text edit boxes, dropdown lists, radio buttons and the like.

In the depicted embodiment is a mobile or desktop web browser application includes several user interface elements including text box 402 displaying the date and element 404 allowing the user to select a suitable time slot from time slots available for the date displayed in text box 402. A plurality of picker profiles are depicted in user profile elements 406a, 406b, 406c, 406d (individually and collectively picker profile element 406). These profile element 406 may be shown in a row element 408 dedicated for displaying picker profiles.

An electronic shopping cart 412 is used to select and place elements 410 from the elements that represent available items for sale. Items 414 in the cart 412 visually represent items selected for purchase. As the skilled reader will readily appreciate, the illustrated user interface is only exemplary, and many alternative user interfaces and interactions for allowing the user or customer to shop for grocery items electronically are possible.

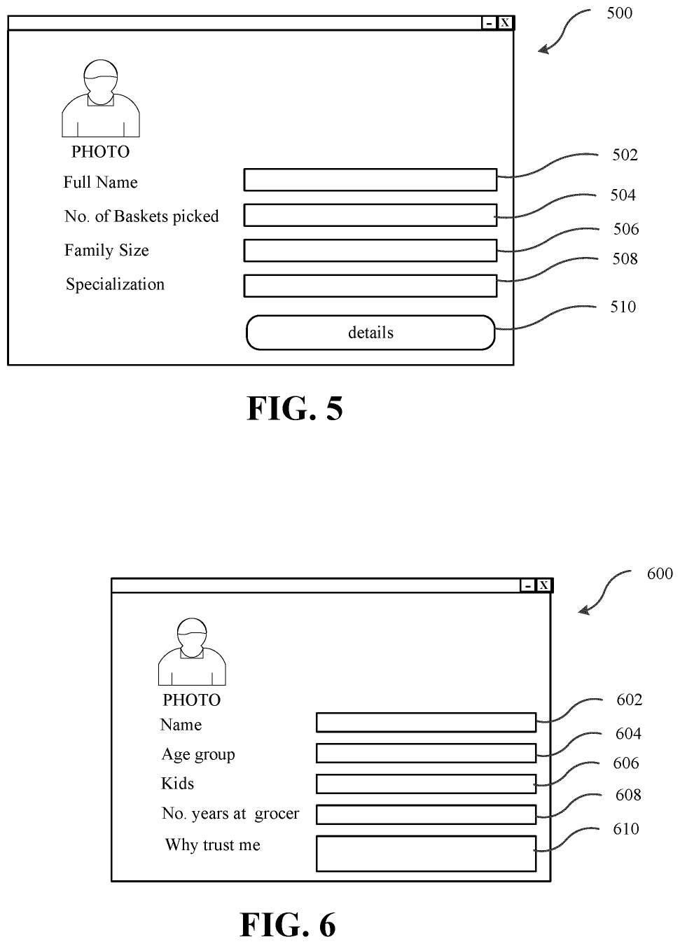

In addition to at least one grocery item, one or more of a payment method, a billing address, a delivery address or a pick up address, a timeslot for picking up or a time slot for delivery, or the like may be specified using application 114 as shown in FIG. 4, FIG. 5 and FIG. 6.

A customer may choose a list of item elements 410 that are placed into the electronic shopping cart 412. The customer may also choose a specific picker using picker profile elements 406a, 406b, 406c, 406d. The choice of a picker is of course optional. In addition, the customer may optionally select one or more timeslots 405 during which he or she would like to pick up their groceries or have the grocery items delivered to a specified destination.

If the preferred picker unavailable to on the day that the customer would like to pick up their groceries, the customer may be notified and will have the option to choose a different picker. For example, upon time slots 405 being selected or changed, user interface 400 of application 114 may redisplay row element 408 with profile elements 406 of only those pickers available during time slots 405 on the date shown in element 402.

Upon a specific profile element of FIG. 4 (e.g., element 406a) being picked, by the customer, a profile window 500 may be displayed by the application 114. The window 500 may depict the full name, number of baskets picked, the family size and specialization of the picker in user interface elements, 502, 504, 506, 508 respectively.

In addition, a details button 510, when selected by the customer, may pop up a details window 600 as shown in FIG. 6. The details window 600 may depict the name, name, age group, number of kinds or children, number of years at the grocer and a text indicating why the picker should be trusted by the customer, in user interface elements, 602, 604, 606, 608, 610 respectively.

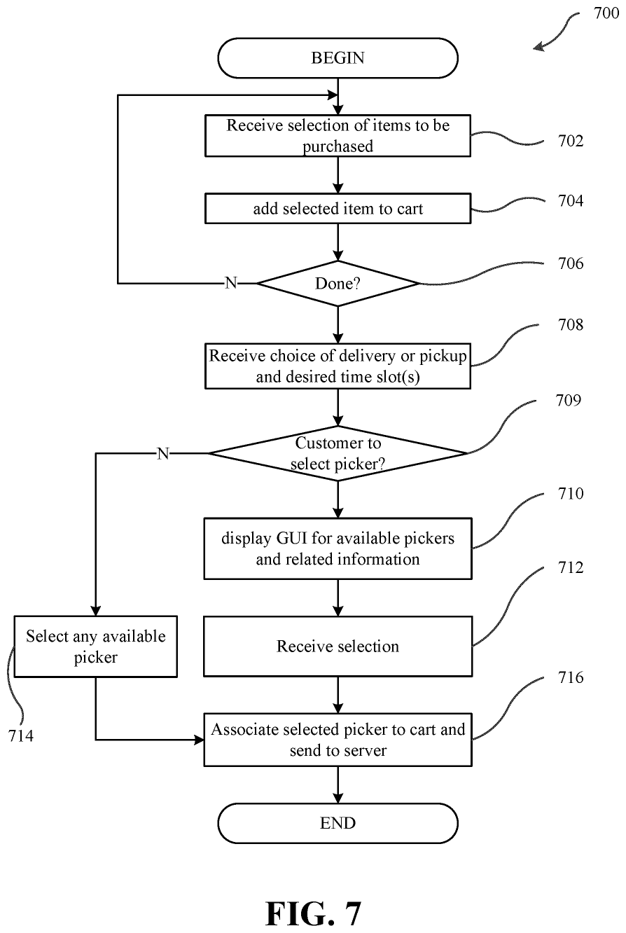

FIG. 7 is a flowchart 700 illustrating a set of exemplary procedural steps taken by a customer's computing device 112 of FIG. 1 running grocery shopping application 114.

In step 702, the device 112 receives selection of items to be purchased as determined by the customer utilizing application 114.

In step 704, the device 112 adds the selected items to an electronic cart utilizing application 114.

In step 706, if there are more items to be added the process proceeds to step 702. Otherwise the next step is step 708 where the application 114 received the consumer's choice of deliver of pickup address and desired time slots for delivery or pickup.

If the consumer wishes to select a picker (step 709) then the application displays a GUI (such as GUI 400 and optionally one or more of window 500 and window 600) of available pickers (step 710) to allow selection of a picker. Upon receiving selection of a picker (step 712) the application 114 then associates the selected picker with the cart (step 716). The association is sent to and stored by server 102 in a processor readable medium so that the picker can actually pick the items indicated in the cart in store 120.

If the consumer does not wish to select a picker (step 709), then the application 114 selects (or allows the server 102 to select) any available picker independent of an input from by the consumer (step 714) and associates the independently selected picker with the cart and the association is sent to and stored by server 102 (step 716).

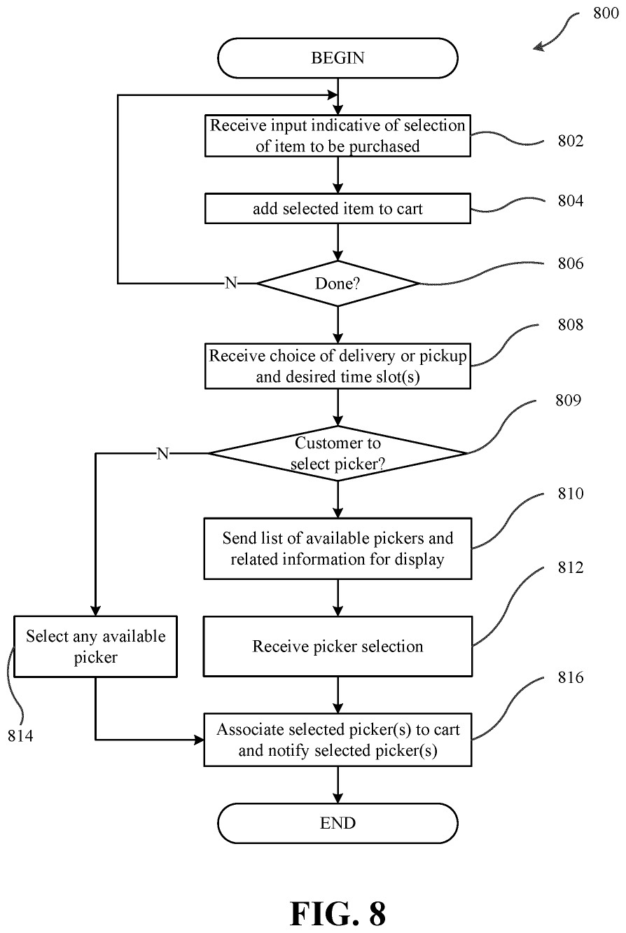

FIG. 8 is a flowchart 800 illustrating a set of exemplary procedural steps taken by the server 102 of FIG. 1 running a server-side software, which may include database 104, app server or application server 108, and business application logic 106 as noted above.

In step 802, the server 102 receives selection of items to be purchased as determined by the customer using his or her app 114.

In step 804, the server 102 adds the selected items to an electronic cart utilizing software 108.

In step 806, if there are more items to be added the process proceeds to step 802. Otherwise, the next step is step 808 where the server 102 receives the consumer's choice of deliver of pickup address and desired time slots for delivery or pickup.

If the consumer is to select a picker (step 809) then the server 102 sends a list of available pickers and related information for display (for example in a GUI such as GUI 400 and optionally one or more of window 500 and window 600) of available pickers (step 810) which allows selection of a picker. Upon receiving selection of a picker (step 812) the server 102 then associates the selected picker with the cart (step 816). The association is stored by server 102 in a processor readable medium.

If the consumer is not to select a picker (step 809), then the server 102 selects (or allows the app 114 to select) any available picker independent of an input from by the consumer (step 814) and associates the independently selected picker with the cart. The association is stored by server 102 and the selected picker(s) are notified (step 816).

The notification may be accomplished by simply storing the data, which is then accessed and displayed at a client device of selected pickers or display board at store 120. The notification may also involve sending an email, text or short message to a computing device of a picker using a wireless or in wired communication means. In addition, audio, video or image signals may be broadcast at or near store 120 in a vicinity or device accessible by the selected pickers. Email, text message, instant message, SMS, blog posting, chat room posting, online bulletin board, Twitter Tweets®, social networking post, chat postings, calendar-sharing, status updates, rich media annotations, telephone call, voice-over-IP call, pagers, other messaging variations and combinations may also be used. Many different ways of notifying or alerting selected pickers will be known to persons of skill in the art.

Advantageously, embodiments of the present invention allow the customer to build trust, build a relationship, and feel safe knowing who is picking out the food for him or her.

The grocer would also find embodiments of the present invention advantageous, as these embodiments allow for optimal allocation of time and other resources based on the needs of the customer and availability of resources.

Both the customer and the grocer are able to bridge the trust gap which can lead to an increase in online sales for perishable as well as non-perishable items, resulting from an increase in customers purchasing online.

Although detailed exemplary embodiments have been discussed in relation to grocery stores, those of skill in the art will readily understand that the invention is not confined to just grocery stores but may be used in any formal or informal physical retail and other spaces where goods, services and other intangibles, are exchanged, sold, bartered or traded.

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A method of electronic commerce comprising:
at a server:
maintaining a plurality of item identifiers corresponding to a plurality of items maintained at a store;
maintaining a plurality of picker profiles corresponding to a plurality of pickers;
receiving an order from a buyer, the order comprising:
an item identifier among said plurality of item identifiers associated with at least one of the plurality of items; and
a picker identifier associated with at least one of said plurality of pickers,
in response to said receiving said order, notifying the at least one of said plurality of pickers associated with the picker identifier,
wherein the at least one of said plurality of pickers selects said at least one of the plurality of items for delivery to said buyer.

2. The method of claim 1, wherein said at least one of the plurality of items is a perishable item.

3. The method of claim 2, wherein said perishable item comprises at least one of a vegetable and a fruit.

4. The method of claim 1, wherein the order further comprises a delivery address, the method further comprising delivering said at least one of the plurality of items to the delivery address.

5. The method of claim 1, wherein said notifying comprises sending a message to a device associated with said at least one of said plurality of pickers associated with the picker identifier.

6. The method of claim 5, wherein said message is comprises one or more of: email, text message, instant message, SMS, blog posting and chat room posting sent to said device.

7. The method of claim 1, further comprising:
providing a list of picker profiles for display,
wherein each picker profile in the list is associated with a picker from said plurality of pickers that is available to pick the at least one of the plurality of items to be purchased at the store.

8. The method of claim 7, wherein the picker profiles in the list are a subset of said plurality of picker profiles.

9. The method of claim 7, further comprising displaying said list in a client computing device in data communication with the server, the client device comprising a processor in communication with a processor readable medium.

10. The method of claim 9, wherein said displaying is performed using browser executing on the processor of the client device.

11. A server system, comprising: a processor; a memory; a communication interface; and a non-transitory processor readable medium storing processor executable instructions configured to be executed by the processor, the processor executable instructions for:
maintaining a plurality of item identifiers corresponding to a plurality of items maintained at a store;
maintaining a plurality of picker profiles corresponding to a plurality of pickers;
receiving an order from a buyer, the order comprising:
an item identifier among said plurality of item identifiers associated with at least one of the plurality of items; and
a picker identifier associated with at least one of said plurality of pickers,
in response to said receiving said order, notifying the at least one of said plurality of pickers associated with the picker identifier,
wherein the at least one of said plurality of pickers selects said at least one of the plurality of items for delivery to said buyer.

12. The server system of claim 11, wherein said notifying comprises sending a notification message to a device associated with said at least one of said plurality of pickers associated with the picker identifier.

13. The server system of claim 12, wherein said notification message comprises at least one of email, text message, instant message, SMS, blog posting, and chat room posting.

14. A client system comprising: a processor; a memory; a communications interface; an input interface and a non-transitory processor readable medium storing processor executable instructions to be executed by the processor, the processor executable instructions comprising instructions for:
receiving, through the input interface, an item identifier among said item identifiers associated with at least one of the plurality of items to be purchased at the store;
receiving, through the input interface, a picker identifier associated with at least one of said plurality of pickers; and
sending the picker identifier and the item identifier to a server system in data communication with the client system through said communications interface.

15. The client system of claim 14, wherein the processor executable instructions further comprise instructions for:
prior to said receiving said picker identifier, receiving a list of a subset of said plurality of picker profiles, wherein pickers associated with the subset are available to pick the at least one of the plurality of items to be purchased.

16. The client system of claim 15, further comprising a display in communication with the processor, wherein the processor executable instructions further comprise instructions for: displaying the list of a subset of said plurality of picker profiles on said display.

17. A non-transitory processor readable medium storing processor executable instructions which when executed by a server computer cause the server to perform a method comprising:
maintaining a plurality of item identifiers corresponding to a plurality of items maintained at a store;
maintaining a plurality of picker profiles corresponding to a plurality of pickers;
receiving an order from a buyer, the order comprising:
an item identifier among said item identifiers associated with at least one of the plurality of items to be purchased at the store; and
a picker identifier associated with at least one of said plurality of pickers,
in response to said receiving said order, notifying the at least one of said plurality of pickers associated with the picker identifier,
wherein the at least one of said plurality of pickers selects said at least one item at the store from for delivery to said buyer.

18. The non-transitory processor readable medium of claim 17, wherein the input further comprises a delivery address, the method further comprising delivering the at least one item to the delivery address.

19. The non-transitory processor readable medium of claim 17, wherein the method further comprises:
providing a list of a subset of said plurality of picker profiles for display,
wherein pickers associated with the subset are available to pick the at least one of the plurality of items to be purchased.

20. The non-transitory processor readable medium of claim 19, wherein the method further comprises:
using a client computing device in data communication with the server, said client device comprising a processor in communication with processor readable medium; and
displaying said list of the subset of the plurality of picker profiles in said client device.
